(19) United States
(12) Patent Application Publication
(10) Pub. No.: US 2024/0007889 A1
(43) Pub. Date: Jan. 4, 2024

(54) MEASUREMENT PROTOCOL FOR RESTRICTED MULTI-LINK DEVICES

(71) Applicant: Telefonaktiebolaget LM Ericsson (publ), Stockholm (SE)

(72) Inventors: Miguel LOPEZ, Aachen (DE); Jonas SEDIN, Brentford Greater London (GB); Abhishek AMBEDE, Huddinge (SE)

(21) Appl. No.: 18/252,406

(22) PCT Filed: Nov. 25, 2021
(86) PCT No.: PCT/EP2021/083069

§ 371 Date: May 10, 2023

Related U.S. Application Data
(60) Provisional application No. 63/119,147, filed on Nov. 30, 2020.

(51) Int. Cl. H04W 24/10

(52) U.S. Cl. CPC H04W 24/10

(57) ABSTRACT

A method, system and apparatus are disclosed. According to one or more embodiments, a network node configured to communicate with a wireless device (WD) is provided. The network node is configured to, and/or includes a radio interface and/or includes processing circuitry configured to transmit a measurement request for the wireless device to perform a measurement on a non-operating channel where the measurement request includes an indication that the network node is configured to prioritize data traffic for the wireless device. The processing circuitry and/or radio interface is further configured to optionally receive a message associated with the measurement request where the message indicates whether the measurement associated with the measurement request was performed.

### FIELD

The present disclosure relates to wireless communications, and in particular, to non-access point (AP) multi-link devices (MILD) for performing measurements.

### INTRODUCTION

### Radio Measurements in IEEE 802.11

The ability to request and report radio measurements is supported in a wireless local area network (WLAN). The usage of the radio measurement framework is to aid the WLAN network in operation and management by measuring quantities such as the received signal strength indicator (RSSI), service load, power state and other operating conditions such as noise histograms, from the perspective of a station (STA). By reporting these measurements to the requesting STA, a better understanding of the operating conditions of the STAs can allow for load balancing, changing the channel to a less interfered one, and adjusting the link adaptation.

As part of the Institute of Electrical and Electronics Engineers (IEEE) 802.11 standard, a STA can ask another STA to perform radio measurements through requesting and reporting. A STA that receives a measurement request may also refuse the request. Some example radio measurements are explained below:
Beacon report and Frame report—which is the signal strength of a Beacon or a frame.
Channel Load Report—The load on a channel, which is a measure of the fraction of time in which the channel is busy.
Noise Histogram Report—which is the measured noise power and interference (IPI—Idle Power Indicator) signaled as a histogram.
STA statistics report—the STA statistics such as number of MSDUs (e.g., MAC service data unit) received during a requested time instance.

The STA can either be requested to measure in the operating channel or in a non-operating channel. In cases where the STA is requested to measure in a non-operating channel, the STA may have to momentarily cancel (or pause) data traffic transmission or reception in order to fulfill the request. A STA could, however, refuse the measurement request, but the STA may then be required to report back that it is refusing to perform the measurement. The reasons for refusing may include reduced quality of service (QoS), unacceptable increase of power consumption, measurement scheduling conflicts, or other factors. For example, for a STA fulfilling a request to perform measurements in a non-operating channel, that STA may have to retune its radio to a center frequency different from the operating channel, thus losing synchronization to the communication medium, thus impairing its ability to quickly transmit or receive. If an urgent packet arrives at the transmit (TX) buffer, the STA may have to first synchronize to the medium, which could be a lengthy process, in addition to contending for the channel or requesting scheduling of uplink (UL) transmission. In summary, sometimes STAs have incentive to refuse performing measurements.

### Multi-Link in IEEE 802.11be

The next-generation major amendment to the IEEE 802.11 WLAN standard, which is currently under development, is IEEE 802.11be (also referred to as Extremely High Throughput ‘EHT’). EHT introduces a feature called multi-link (ML). In ML, a multi-link device (MLD) has multiple affiliated STAs, each of which can communicate using independent wireless channels (links). Communication over multiple links by an MLD is called multi-link operation (MLO). As used herein, the terms ‘channels’ and ‘links’ are used interchangeably. For example, an MLD can have two affiliated STAs—one communicating using channels in the 5 GHz frequency band and the other communicating using channels in the 6 GHz frequency band. Alternatively, as another example, an MLD can have two affiliated STAs—each communicating using channels in the 6 GHz frequency band.

An MLD can use its affiliated STAs and corresponding supported channels to perform simultaneous TX MLO (e.g., multi-link operation), simultaneous receive (RX) MLO, or simultaneous transmit and receive (STR) MLO. If a TX operation on one channel results in inability to perform RX operation on another channel, that pair of channels is classified as non-STR (NSTR). An MLD may announce its STR capability related to a pair of supported channels.

IEEE 802.11be introduces two types of MLDs with reduced multi-link capabilities: one which operates in what is referred to as Enhanced Multi-Link Single Radio (EMLSR) mode and another one operating in Enhanced Multi-Link Multi Radio (EMLMR) mode.

EMLSR enables an MLD to listen to two or more preconfigured channels simultaneously, thus allowing rapid switching between links. The listening operation includes clear channel assessment (CCA) and receiving the initial control frame of a frame exchange sequence (e.g., request to send (RTS)/clear to send (CTS)) that is initiated by an AP MLD. Moreover, the EMLSR MLD may be unable to transmit or receive frames on more than one link simultaneously. In a typical application, a non-AP device supporting MIMO would reconfigure the radio chains so that it is able to listen to two or more channels simultaneously (e.g., a 2×2 MIMO radio may be configured for operation as 1×1 on 5 GHz and 1×1 on 6 GHz). Devices supporting EMLSR mode are attractive because they provide some of the gains of MLO but at a lower cost and complexity than full blown MLDs.

EMLMR enables an MLD to listen as well as transmit on two or more preconfigured channels simultaneously by dividing up the radio chains on different channels. Thus, when the MLD operates in this mode, MLD may be able to receive and transmit PPDUs with the number of spatial streams as indicated in its capabilities, where the number of spatial streams per link will be less than the total number of spatial streams if it operates on a single link. Thus, it is similar to EMLSR in that it uses its receive antennas that are normally used for MIMO, but the difference being that it can use them to transmit and receive simultaneously.

However, as the IEEE 802.11 standard has evolved, support for networks where access to the communication medium is controlled by the access point (AP) has increased. For example, the 802.1 lax amendment introduced trigger frames that enable the AP to schedule UL transmissions from stations (STAs), and in IEEE 802.11be there are plans to support multi-AP systems where the AP's collaborate in the allocation of radio resources. Centrally controlled networks such as mobile networks rely on measurement reports from the user equipments (UEs) in order to allocate resources and schedule users. However, in IEEE 802.11 networks, the STAs may refuse to perform measurements, which makes scheduling, frequency planning and resource allocation more difficult for the APs.

Thus, MLDs could, in theory, support measurements in several channels. However, MLDs with restrictions, such as NSTR and EMLSR, may still be disincentivized to perform measurements as they may be subject to QoS degradations when performing measurements. For example, an NSTR MLD engaged in a low latency transmission (e.g., high priority access voice) may refuse to listen to a non-operating channel on a second link as this would prevent it from transmitting a packet on an operating channel. Similarly, an EMLSR MLD may only receive low data rates when listening to several links, and hence may refuse to perform measurements.

### SUMMARY

Aspects of the invention are defined in the appended independent claims. Embodiments thereof are defined by the dependent claims.

Some embodiments advantageously provide methods, systems, and apparatuses for non-access point (AP) multi-link devices (MLD) for performing measurements.

One or more embodiments relate to non-AP MLDs with restricted MLO capabilities. For example, when the AP requests a measurement on a non-operating channel, the AP may also guarantee the restricted non-AP MLD downlink (DL)/UL access to the communication medium without increased delay or decreased data rate.

One or more embodiments provide one or more of the following advantages:
provides more efficient use of multi-link capabilities to perform measurements.
removes disincentives for restricted non-AP MLDs to perform measurements. This is useful in practice because restricted non-AP MLDs are expected to be cheaper and less complex than fully capable MLDs, and hence restricted non-AP MLDs could find wide applicability and perhaps greater commercial success than fully capable MLDs

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to the principles in the present disclosure;

FIG. 2 is a block diagram of a portion of the example network architecture according to some embodiments of the present disclosure;

FIG. 3 is a flowchart of an example process in a network node according to some embodiments of the present disclosure;

FIG. 4 is a flowchart of an example process in a wireless device according to some embodiments of the present disclosure;

FIG. 5 is a signaling diagram of an example measurement procedure according to some embodiments of the present disclosure;

FIG. 6 is a signaling diagram of an example measurement request with downlink data priority according to some embodiments of the present disclosure;

FIG. 7 is a signaling diagram of an example measurement request with uplink data priority according to some embodiments of the present disclosure;

FIG. 8 is a signaling diagram of another example measurement request with uplink data priority according to some embodiments of the present disclosure; and

FIG. 9 is a signaling diagram of an example downlink data priority when non-AP MLD operates in EMLMR mode according to some embodiments of the present disclosure.

### DETAILED DESCRIPTION

Before describing in detail exemplary embodiments, it is noted that the embodiments reside primarily in combinations of apparatus components and processing steps related to non-AP MLDs for performing measurements.

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of an access point, IEEE based access point, base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. In one or more embodiments, network node is used interchangeably with access point.

In some embodiments, the non-limiting terms wireless device (WD), a user equipment (UE) and non-MLD AP are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Note that although terminology from one particular wireless system, such as, for example, IEEE, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

An indication generally may explicitly and/or implicitly indicate the information it represents and/or indicates. Implicit indication may, for example, be based on position and/or resource used for transmission. Explicit indication may, for example, be based on one or more parameters, and/or one or more index or indices, and/or one or more bit patterns representing the information.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication, for example, between base stations or similar network nodes, in particular communication terminating at such. It may be considered that backhaul and/or relay communication and/or network communication is implemented as a form of sidelink or uplink communication or similar thereto.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide non-AP MLDs for performing measurements where the AP may prioritize non-AP MLD data communications.

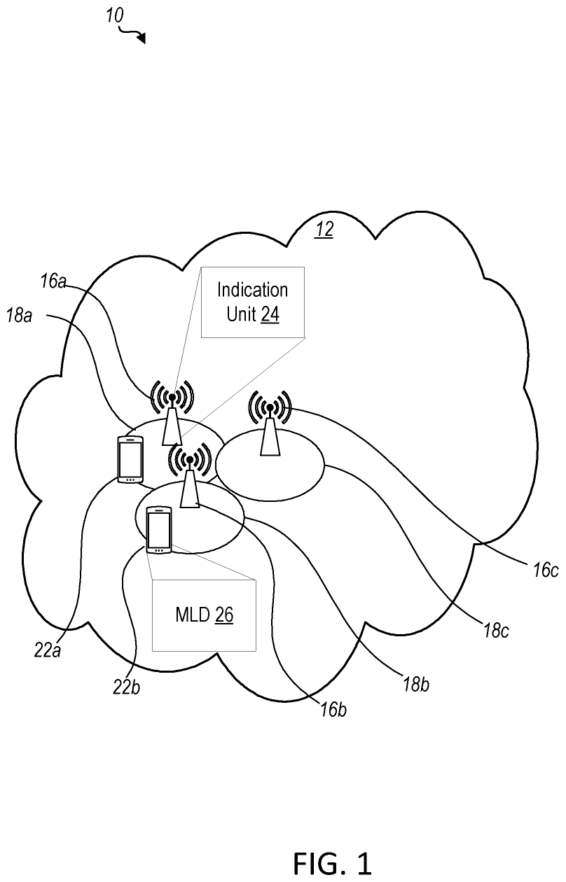

Referring now to the drawing figures, in which like elements are referred to by like reference numerals, there is shown in FIG. 1 a schematic diagram of a communication system 10, according to an embodiment, such as an IEEE based network or a 3GPP-type cellular network that may support standards such as LTE and/or NR (5G), which comprises network 12 such as a wireless local area network (WLAN) or other IEEE based network, for example. The network 12 comprises a plurality of network nodes 16a, 16b, 16c (referred to collectively as network nodes 16), such as wireless access points, each defining a corresponding coverage area 18a, 18b, 18c (referred to collectively as coverage areas 18). A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE/5G and the same or a different network node 16 that supports IEEE based standards.

As an example, WD 22 can be in communication with an eNB for LTE/E-UTRAN and/or a gNB for NR/NG-RAN, and also a wireless access point as described herein.

A network node 16 is configured to include an indication unit 24 which is configured to perform one or more network node 16 functions as described herein such as with respect to non-AP MLDs for performing measurements. A wireless device 22 is configured to include a MLD unit 26 which is configured to perform one or more network nodes 16 functions as described herein such as with respect to non-AP MLDs for performing measurements.

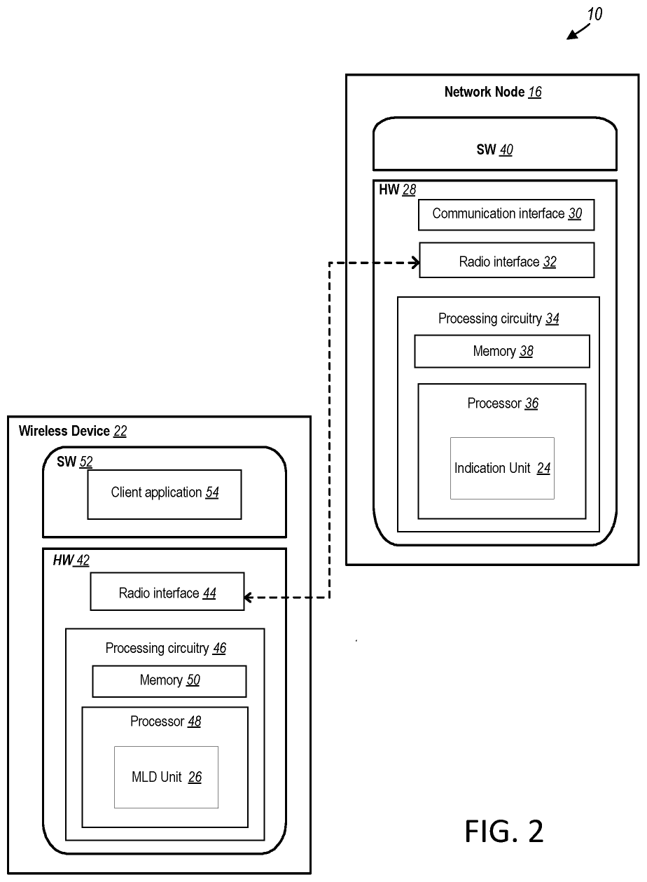

Example implementations, in accordance with an embodiment, of the WD 22 and network node 16 discussed in the preceding paragraphs will now be described with reference to FIG. 2. Communication system 10 includes a network node 16 provided in a communication system 10 and including hardware 28 enabling it to communicate with the WD 22. The hardware 28 may include a communication interface 30 for setting up and maintaining a wired or wireless connection with an interface of a different communication device of the communication system 10, as well as a radio interface 32 for setting up and maintaining at least a wireless connection with a WD 22 located in a coverage area 18 served by the network node 16. The radio interface 32 may be formed as or may include, for example, one or more RF transmitters, one or more RF receivers, and/or one or more RF transceivers.

In the embodiment shown, the hardware 28 of the network node 16 further includes processing circuitry 34. The processing circuitry 34 may include a processor 36 and a memory 38. In particular, in addition to or instead of a processor, such as a central processing unit, and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 40 stored internally in, for example, memory 38, or stored in external memory (e.g., database, storage array, network storage device, etc.) accessible by the network node 16 via an external connection. The software 40 may be executable by the processing circuitry 34. The processing circuitry 34 may be configured to control any of the methods and/or processes described herein and/or to cause such methods, and/or processes to be performed, e.g., by network node 16. Processor 36 corresponds to one or more processors 36 for performing network node 16 functions described herein. The memory 38 is configured to store data, programmatic software code and/or other information described herein. In some embodiments, the software 40 may include instructions that, when executed by the processor 36 and/or processing circuitry 34, causes the processor 36 and/or processing circuitry 34 to perform the processes described herein with respect to network node 16. For example, processing circuitry 34 of the network node 16 may include indication unit 24 configured to perform one or more network node 16 functions as described herein such as with respect to non-AP MLDs for performing measurements.

The communication system 10 further includes the WD 22 already referred to. The WD 22 may have hardware 42 that may include a radio interface 44 configured to set up and maintain a wireless connection with a network node 16 serving a coverage area 18 in which the WD 22 is currently located. The radio interface 44 may be formed as or may include, for example, one or more RF transmitters, one or more RF receivers, and/or one or more RF transceivers.

The hardware 42 of the WD 22 further includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 52, which is stored in, for example, memory 50 at the WD 22, or stored in external memory (e.g., database, storage array, network storage device, etc.) accessible by the WD 22. The software 52 may be executable by the processing circuitry 46. The software 52 may include a client application 54. The client application 54 may be operable to provide a service to a human or non-human user via the WD 22. The client application 54 may interact with the user to generate the user data that it provides.

The processing circuitry 46 may be configured to control any of the methods and/or processes described herein and/or to cause such methods, and/or processes to be performed, e.g., by WD 22. The processor 48 corresponds to one or more processors 48 for performing WD 22 functions described herein. The WD 22 includes memory 50 that is configured to store data, programmatic software code and/or other information described herein. In some embodiments, the software 52 and/or the client application 54 may include instructions that, when executed by the processor 48 and/or processing circuitry 46, causes the processor 48 and/or processing circuitry 46 to perform the processes described herein with respect to WD 22. For example, the processing circuitry 46 of the wireless device 22 may include a MILD unit 26 configured to perform one or more wireless device 22 functions as described herein such as with respect to non-AP MLDs for performing measurements.

In some embodiments, the inner workings of the network node 16 and WD 22 may be as shown in FIG. 2 and independently, the surrounding network topology may be that of FIG. 1.

Although FIGS. 1 and 2 show various “units” such as indication unit 24 and MLD unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

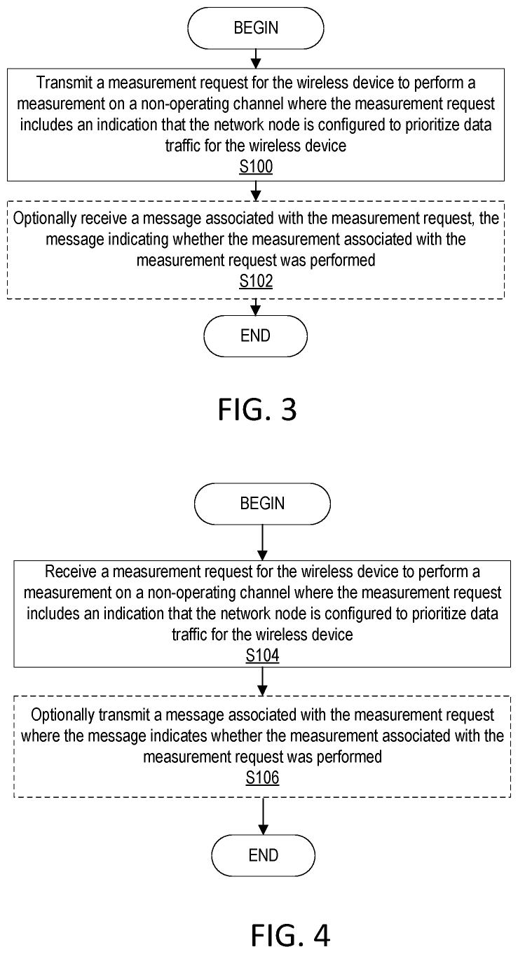

FIG. 3 is a flowchart of an exemplary process in a network node 16 according to some embodiments of the present disclosure. One or more Blocks and/or functions performed by network node 16 may be performed by one or more elements of network node 16 such as by indication unit 24 in processing circuitry 34, processor 36, radio interface 32, etc. In one or more embodiments, network node 16 such as via one or more of processing circuitry 34, processor 36, indication unit 24, communication interface 30 and radio interface 32 is configured to cause transmission (Block S100) of a measurement request for the wireless device 22 to perform a measurement on a non-operating channel where the measurement request includes an indication that the network node 16 is configured to prioritize data traffic for the wireless device 22, as described herein. In one or more embodiments, network node 16 such as via one or more of processing circuitry 34, processor 36, indication unit 24, communication interface 30 and radio interface 32 is configured to optionally receive (Block S102) a message associated with the measurement request where the message indicates whether the measurement associated with the measurement request was performed, as described herein.

According to one or more embodiments, the message is a measurement report that indicates the results of the measurement. According to one or more embodiments, the message indicates one of the measurements was completed and the measurement is incomplete. According to one or more embodiments, the prioritizing of data traffic for the wireless device corresponds to providing a downlink priority indication where the network node indicates that downlink data addressed to the wireless device is configured to be transmitted with less than a predefined delay or without a decreased data rate. That is, the prioritizing of data traffic for the wireless device corresponds to providing a downlink priority indication where the network node indicates that reception of downlink data addressed to the wireless device needs to be undertaken with higher priority over performing a measurement or measurement reporting. According to one or more embodiments, the prioritizing of data traffic for the wireless device corresponds providing an uplink priority indication where the network node indicates that the wireless device is provided with a higher priority to access a communication medium than the priority associated with another wireless device. That is, the prioritizing of data traffic for the wireless device corresponds to providing an uplink priority indication where the network node indicates that transmission of uplink data addressed to the network node needs to be undertaken with higher priority over performing a measurement or measurement reporting. According to one or more embodiments, the prioritizing of data traffic for the wireless device corresponds to receiving a downlink priority indication where the network node indicates that reception of downlink data addressed to the wireless device needs to be undertaken with higher priority over performing a measurement or measurement reporting. According to one or more embodiments, the prioritizing of data traffic for the wireless device corresponds to receiving an uplink priority indication where the network node indicates that transmission of uplink data addressed to the network node needs to be undertaken with higher priority over performing a measurement or measurement reporting

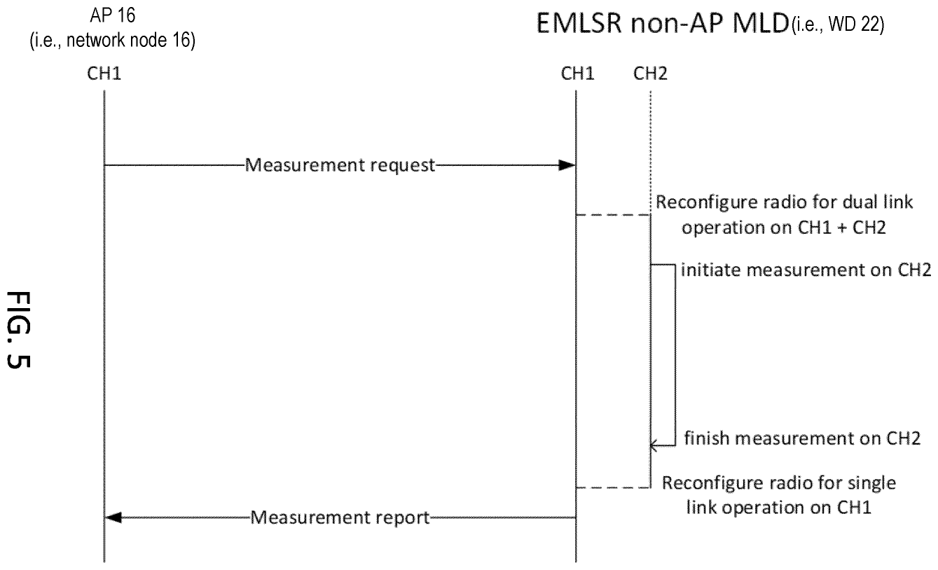

FIG. 4 is a flowchart of an example process in a wireless device 22 according to some embodiments of the present disclosure. One or more Blocks and/or functions performed by wireless device 22 may be performed by one or more elements of wireless device 22 such as by MILD unit 26 in processing circuitry 46, processor 48, radio interface 44, etc. In one or more embodiments, wireless device such as via one or more of processing circuitry 46, processor 48, MILD unit 26 and radio interface 44 is configured to receive (Block S104) a measurement request for the wireless device to perform a measurement on a non-operating channel where the measurement request includes an indication that the network node is configured to prioritize data traffic for the wireless device, as described herein. In one or more embodiments, wireless device such as via one or more of processing circuitry 46, processor 48, MILD unit 26 and radio interface 44 is configured to optionally transmit (Block S106) a message associated with the measurement request where the message indicates whether the measurement associated with the measurement request was performed, as described herein.

According to one or more embodiments, the message is a measurement report that indicates the results of the measurement. According to one or more embodiments, the message indicates one of the measurements was completed and the measurement is incomplete. According to one or more embodiments, the prioritizing of data traffic for the wireless device corresponds to receiving a downlink priority indication where the network node indicates that downlink data addressed to the wireless device is configured to be transmitted with less than a predefined delay or without a decreased data rate. That is, the prioritizing of data traffic for the wireless device corresponds to receiving a downlink priority indication where the network node indicates that reception of downlink data addressed to the wireless device needs to be undertaken with higher priority over performing a measurement or measurement reporting. According to one or more embodiments, the prioritizing of data traffic for the wireless device corresponds receiving an uplink priority indication where the network node indicates that the wireless device is provided with a higher priority to access a communication medium than the priority associated with another wireless device. That is, the prioritizing of data traffic for the wireless device corresponds to receiving an uplink priority indication where the network node indicates that transmission of uplink data addressed to the network node needs to be undertaken with higher priority over performing a measurement or measurement reporting.

Having generally described arrangements for non-AP MLDs for performing measurements, details for these arrangements, functions and processes are provided as follows, and which may be implemented by the network node 16 (also referred to herein as access point 16 (AP 16)) and/or wireless device 22 (also referred to herein as non-AP MLD 22).

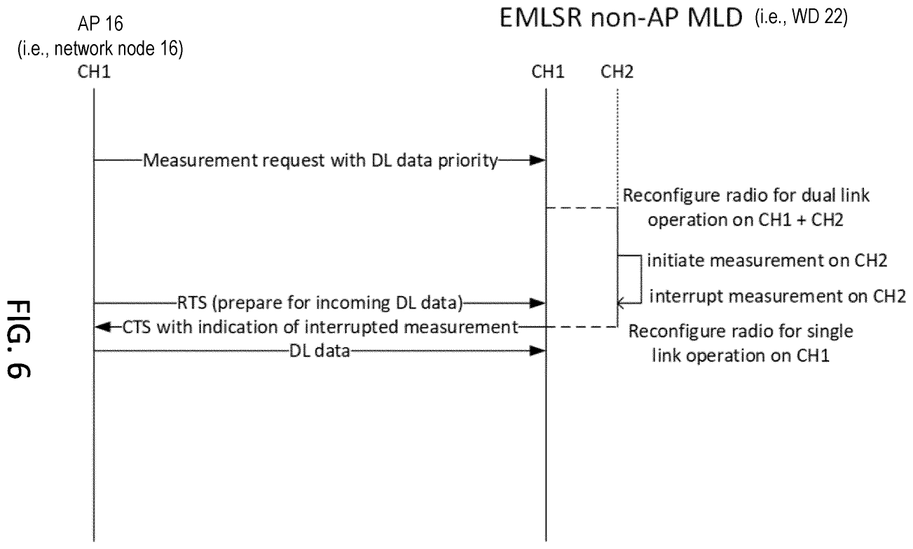

Some embodiments provide non-AP MLDs 22 for performing measurements. Consider first EMLSR non-AP MLDs 22. These MLDs 22 such as via one or more of processing circuitry 46, processor 48, radio interface 44, MLD unit 26, etc., are capable of reconfiguring their MIMO radio to simultaneously listen in two different channels. Thus, these MHLDs 22 such as via one or more of processing circuitry 46, processor 48, radio interface 44, MLD unit 26, etc., could perform measurements on a non-operating channel without losing synchronization to the communication medium, as illustrated in FIG. 5. In the example of FIG. 5, CH1 is an operating channel, and CH2 is a non-operating channel where the AP 16 wants to obtain measurements.

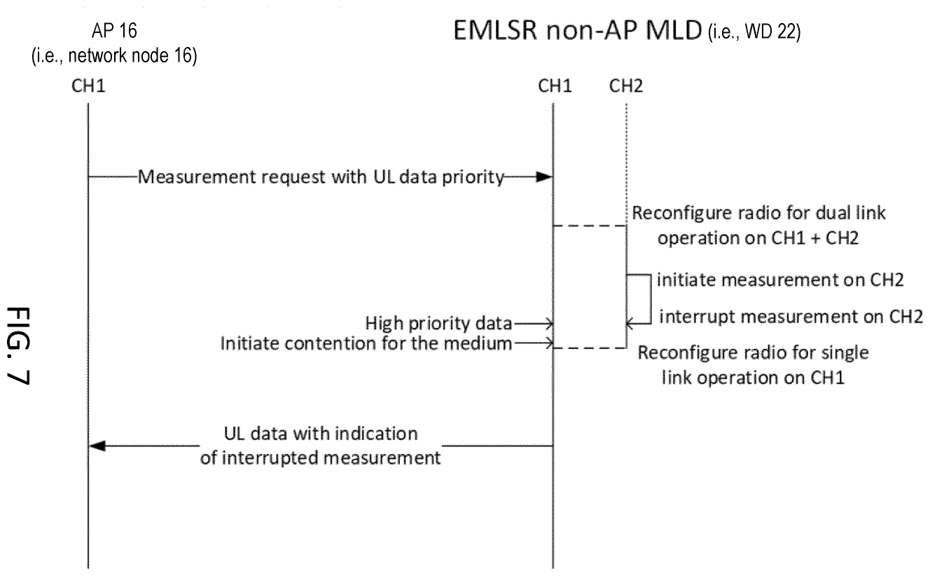

In one or more embodiments, the measurement request, transmitted to the MLD 22 by the AP 16 such as via one or more of processing circuitry 34, processor 36, radio interface 32, indication unit 24, etc., includes an indication of DL data priority. An EMLSR non-AP MLD 22 such as via one or more of processing circuitry 46, processor 48, radio interface 44, MLD unit 26, etc., receiving a measurement request including a DL data priority indication knows that the AP 16 guarantees or is configured such that DL data addressed to EMLSR non-AP MLD 22 will be delivered without delay (i.e., with no delay or with delay less than a predefined amount) or decreased data rate. When the AP 16 such as via one or more of processing circuitry 34, processor 36, radio interface 32, indication unit 24, etc., receives data for the EMLSR non-AP MLD 22 before the AP 16 has received the measurement report, the AP 16 such as via one or more of processing circuitry 34, processor 36, radio interface 32, indication unit 24, etc., sends an RTS to the EMLSR non-AP MLD 22 indicating that there is DL data. The EMLSR non-AP MLD 22 such as via one or more of processing circuitry 46, processor 48, radio interface 44, MLD unit 26, etc., may interrupt the measurement on the non-operating channel and reconfigure the radio for single link operation, and reply with a CTS. The AP 16 such as via one or more of processing circuitry 34, processor 36, radio interface 32, indication unit 24, etc., sends the DL data upon reception of the CTS. The CTS may include an indication that the measurement was not completed. The procedure is illustrated in FIG. 6.

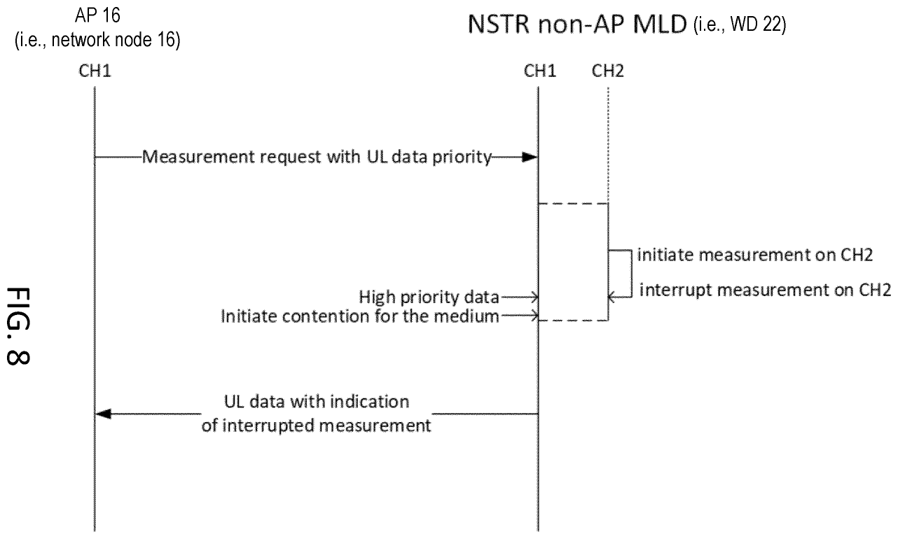

In one or more embodiments, when the AP 16 such as via one or more of processing circuitry 34, processor 36, radio interface 32, indication unit 24, etc., requests a measurement from an EMLSR non-AP MLD 22, the AP 16 such as via one or more of processing circuitry 34, processor 36, radio interface 32, indication unit 24, etc., indicates UL data priority. If the EMLSR non-AP MLD 22 such as via one or more of processing circuitry 46, processor 48, radio interface 44, MLD unit 26, etc., receives high priority data for UL transmission, the E-LSR non-AP MLD 22 such as via one or more of processing circuitry 46, processor 48, radio interface 44, MLD unit 26, etc., may interrupt any ongoing measurements, reconfigure the radio for single link operation and attempt to access the communication medium to perform an UL data transmission. The EMLSR non-AP MLD 22 such as via one or more of processing circuitry 46, processor 48, radio interface 44, MLD unit 26, etc., may also indicate to the AP 16 that the measurement was not completed. This indication may be included in an element, for example, in the MAC header in the UL data frame. The procedure is illustrated in FIG. 7.

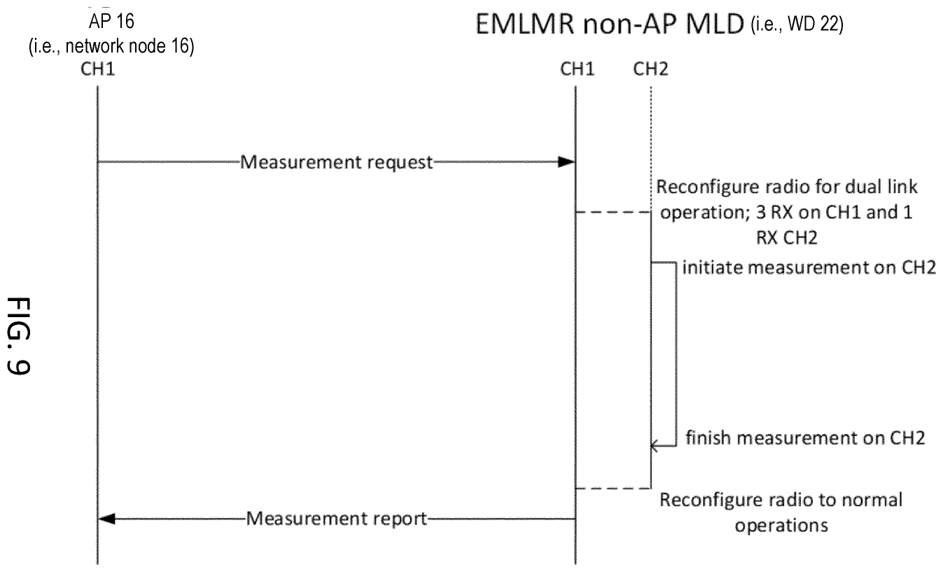

One or more embodiments relate to NSTR non-AP MLDs 22. For example, when the AP 16 such as via one or more of processing circuitry 34, processor 36, radio interface 32, indication unit 24, etc., requests a measurement from an NSTR non-AP MLD 22, the AP 16 such as via one or more of processing circuitry 34, processor 36, radio interface 32, indication unit 24, etc., indicates UL data priority. If the NSTR non-AP MLD 22 such as via one or more of processing circuitry 46, processor 48, radio interface 44, MLD unit 26, etc., receives high priority data for UL transmission, the NSTR non-AP MLD 22 such as via one or more of processing circuitry 46, processor 48, radio interface 44, MLD unit 26, etc., may interrupt any ongoing measurements (e.g., measurement(s) requested by the AP 16) and attempt to access the communication medium to perform an UL data transmission. The NSTR non-AP MLD 22 such as via one or more of processing circuitry 46, processor 48, radio interface 44, MLD unit 26, etc., may also indicate to the AP 16 that the measurement was not completed or incomplete. This indication may be included in an element, for example, in the MAC header in the UL data frame. The procedure is illustrated in FIG. 8.

The indication of interrupted measurement that is transmitted by the MLD 22 such as via one or more of processing circuitry 46, processor 48, radio interface 44, MLD unit 26, etc., as shown in FIG. 6, FIG. 7 and FIG. 8, is useful since the AP 16 may benefit from knowing whether the measurement was finished. It may happen that the restricted non-AP MLD 22 has concluded the measurement but has not sent the report yet, in which case there is no need to make a new measurement request. If, on the other hand, the measurement request was interrupted, the AP 16 such as via one or more of processing circuitry 34, processor 36, radio interface 32, indication unit 24, etc., may send another measurement request to the same or other non-AP MLD 22.

One or more embodiments described herein consider EMLMR non-AP MLDs 22. When a measurement is requested, the AP 16 such as via one or more of processing circuitry 34, processor 36, radio interface 32, indication unit 24, etc., may indicate a DL and UL priority indicates the relative importance of the requested measurement. If the measurement is indicated to be prioritized, the non-AP MLD 22 such as via one or more of processing circuitry 46, processor 48, radio interface 44, MLD unit 26, etc., will continue to measure on the requested channel in 1×1 MIMO mode, while receiving data on the other link. Else if the measurement is not indicated to be prioritized, the non-AP MLD 22 will interrupt the measurement and have all of the MIMO resources be used at the channel where the data arrives. As an example, if the non-AP MLD 22 has 4 RX antennas, then one antenna may be used by the non-AP MLD 22 to measure on another channel while the remaining 3 RX antennas may be used to receive data and if priority is not indicated, all of the 4 RX antennas may be used to receive the DL data. This example is illustrated in FIG. 9.

### SOME EXAMPLES

Example 1. A protocol to request and report measurements in a wireless network 12 including an AP 16 and restricted non-AP MLD 22, wherein the AP 16 sends a measurement request to the restricted non-AP MLD 22, the measurement request including at least one of an indication of UL data priority and an indication of DL data priority.

Example 2. The protocol of Example 1, wherein the measurement request includes an indication of UL data priority, where the restricted non-AP MLD 22 transmits UL data before completing the request to perform a measurement.

Example 3. The protocol of any one of Example 1 and Example 2, wherein the UL data transmitted by the restricted non-AP MLD includes an indication of an interrupted measurement.

Example 4. The protocol of Example 1, wherein the measurement request includes an indication of DL data priority, and where the AP 16 transmits a control message (RTS) to the restricted non-AP MLD 22 including an indication of upcoming DL data prior to reception of the requested measurement report.

Example 5. The protocol of any one of Examples 1 and 4, wherein the restricted non-AP MLD 22 responds to the control message (e.g., request to send (RTS)) within SIFS (e.g., short inter-frame space) with another control message (CTS), the control message optionally including an indication of that the measurement was interrupted.

Example 6. The protocol of any one of Examples 1, 4 and 5, wherein the AP 16 sends DL data to the restricted non-AP MLD 22 within SIFS upon reception of the control message.

Example 7. The protocol of any one of Examples 1-6, wherein the restricted non-AP MLD 22 is one of an EMLSR MLD 22, NSTR MLD 22 and EMLMR MLD 22.

Example 8. The protocol of any one of Examples 1-7, wherein the restricted non-AP MLD 22 is an EMLSR MLD 22 and reconfigures its radio for single link operation upon reception of the RTS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AP | Access Point |
| CTS | Clear To Send |
| DL | Downlink |
| EHT | Extremely High Throughput |
| EMLSR | Enhanced Multi-Link Single Radio |
| IPI | Idle Power Indicator |
| MAC | Medium Access Control |
| MIMO | Multiple Input Multiple Output |
| ML | Multi-Link |
| MLD | Multi-Link Device |
| MLO | Multi-Link Operation |
| NSTR | Non-STR |
| QoS | Quality of Service |
| RSSI | Received Signal Strength Indicator |
| RX | Receive or Receiver |
| STA | Station |
| RTS | Request To Send |
| STR | Simultaneous Transmit and Receive |
| TX | Transmit or Transmitter |
| UE | User Equipment |
| UL | Uplink |
| WLAN | Wireless Local Area Network |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A network node configured to communicate with a wireless device (WD), the network node configured to, and/or comprising a radio interface and/or comprising processing circuitry configured to:

transmit a measurement request for the wireless device to perform a measurement on a non-operating channel, the measurement request including an indication that the network node is configured to prioritize data traffic for the wireless device; and

optionally receive a message associated with the measurement request, the message indicating whether the measurement associated with the measurement request was performed.

Embodiment A2. The network node of Embodiment A1, wherein the message is a measurement report that indicates the results of the measurement.

Embodiment A3. The network node of Embodiment A1, wherein the message indicates one of the measurement was completed and the measurement is incomplete.

Embodiment A4. The network node of any one of Embodiments A1-A3, wherein the prioritizing of data traffic for the wireless device corresponds to providing a downlink priority indication where the network node indicates that downlink data addressed to the wireless device is configured to be transmitted with less than a predefined delay or without a decreased data rate.

Embodiment A5. The network node of any one of Embodiments A1-A3, wherein the prioritizing of data traffic for the wireless device corresponds providing an uplink priority indication where the network node indicates that the wireless device is provided with a higher priority to access a communication medium than the priority associated with another wireless device.

Embodiment B1. A method implemented in a network node that is configured to communicate with a wireless device, the method comprising:

transmitting a measurement request for the wireless device to perform a measurement on a non-operating channel, the measurement request including an indication that the network node is configured to prioritize data traffic for the wireless device; and

optionally receiving a message associated with the measurement request, the message indicating whether the measurement associated with the measurement request was performed.

Embodiment B2. The method of Embodiment B1, wherein the message is a measurement report that indicates the results of the measurement.

Embodiment B3. The method of Embodiment B1, wherein the message indicates one of the measurement was completed and the measurement is incomplete.

Embodiment B4. The method of any one of Embodiments B1-B3, wherein the prioritizing of data traffic for the wireless device corresponds to providing a downlink priority indication where the network node indicates that downlink data addressed to the wireless device is configured to be transmitted with less than a predefined delay or without a decreased data rate.

Embodiment B5. The method of any one of Embodiments B1-B3, wherein the prioritizing of data traffic for the wireless device corresponds providing an uplink priority indication where the network node indicates that the wireless device is provided with a higher priority to access a communication medium than the priority associated with another wireless device.

Embodiment C1. A wireless device (WD) configured to communicate with a network node, the WD configured to, and/or comprising a radio interface and/or processing circuitry configured to:

receive a measurement request for the wireless device to perform a measurement on a non-operating channel, the measurement request including an indication that the network node is configured to prioritize data traffic for the wireless device; and

optionally transmit a message associated with the measurement request, the message indicating whether the measurement associated with the measurement request was performed.

Embodiment C2. The wireless device of Embodiment C1, wherein the message is a measurement report that indicates the results of the measurement.

Embodiment C3. The wireless device of Embodiment C1, wherein the message indicates one of the measurement was completed and the measurement is incomplete.

Embodiment C4. The wireless device of any one of Embodiments C1-C3, wherein the prioritizing of data traffic for the wireless device corresponds to receiving a downlink priority indication where the network node indicates that downlink data addressed to the wireless device is configured to be transmitted with less than a predefined delay or without a decreased data rate.

Embodiment C5. The wireless device of any one of Embodiments C1-C3, wherein the prioritizing of data traffic for the wireless device corresponds receiving an uplink priority indication where the network node indicates that the wireless device is provided with a higher priority to access a communication medium than the priority associated with another wireless device.

Embodiment D1. A method implemented in a wireless device (WD) that is configured to communicate with a network node, the method comprising:

receiving a measurement request for the wireless device to perform a measurement on a non-operating channel, the measurement request including an indication that the network node is configured to prioritize data traffic for the wireless device; and

optionally transmitting a message associated with the measurement request, the message indicating whether the measurement associated with the measurement request was performed.

Embodiment D2. The method of Embodiment D1, wherein the message is a measurement report that indicates the results of the measurement.

Embodiment D3. The method of Embodiment D1, wherein the message indicates one of the measurement was completed and the measurement is incomplete.

Embodiment D4. The method of any one of Embodiments D1-D3, wherein the prioritizing of data traffic for the wireless device corresponds to receiving a downlink priority indication where the network node indicates that downlink data addressed to the wireless device is configured to be transmitted with less than a predefined delay or without a decreased data rate.

Embodiment D5. The method of any one of Embodiments D1-D3, wherein the prioritizing of data traffic for the wireless device corresponds receiving an uplink priority indication where the network node indicates that the wireless device is provided with a higher priority to access a communication medium than the priority associated with another wireless device.

1. A network node configured to communicate with a wireless device, the network node configured to:
transmit a measurement request for the wireless device to perform a measurement on a non-operating channel, the measurement request including an indication that the network node is configured to prioritize data traffic for the wireless device; and
receive a message associated with the measurement request, the message indicating whether the measurement associated with the measurement request was performed.

2. The network node of claim 1, wherein the message is a measurement report that indicates the results of the measurement.

3. The network node of claim 1, wherein the message indicates one of:
the measurement was completed, and
the measurement is incomplete.

4. The network node of claim 1, wherein the prioritizing of data traffic for the wireless device corresponds to providing a downlink priority indication where the network node indicates that reception of downlink data addressed to the wireless device needs to be undertaken with higher priority over performing a measurement or measurement reporting.

5. The network node of claim 1, wherein the prioritizing of data traffic for the wireless device corresponds to providing an uplink priority indication where the network node indicates that transmission of uplink data addressed to the network node needs to be undertaken with higher priority over performing a measurement or measurement reporting.

6. A method implemented in a network node that is configured to communicate with a wireless device, the method comprising:
transmitting a measurement request for the wireless device to perform a measurement on a non-operating channel, the measurement request including an indication that the network node is configured to prioritize data traffic for the wireless device; and
receiving a message associated with the measurement request, the message indicating whether the measurement associated with the measurement request was performed.

7. The method of claim 6, wherein the message is a measurement report that indicates the results of the measurement.

8. The method of claim 6, wherein the message indicates one of:
the measurement was completed, and
the measurement is incomplete.

9. The method of claim 6, wherein the prioritizing of data traffic for the wireless device corresponds to providing a downlink priority indication where the network node indicates that reception of downlink data addressed to the wireless device needs to be undertaken with higher priority over performing a measurement or measurement reporting.

10. The method of claim 6, wherein the prioritizing of data traffic for the wireless device corresponds to providing an uplink priority indication where the network node indicates that transmission of uplink data addressed to the network node needs to be undertaken with higher priority over performing a measurement or measurement reporting.

11. A wireless device configured to communicate with a network node, the wireless device configured to:
receive a measurement request for the wireless device to perform a measurement on a non-operating channel, the measurement request including an indication that the network node is configured to prioritize data traffic for the wireless device; and
transmit a message associated with the measurement request, the message indicating whether the measurement associated with the measurement request was performed.

12. The wireless device of claim 11, wherein the message is a measurement report that indicates the results of the measurement.

13. The wireless device of claim 11, wherein the message indicates one of:
the measurement was completed, and
the measurement is incomplete.

14. The wireless device of claim 11, wherein the prioritizing of data traffic for the wireless device corresponds to receiving a downlink priority indication where the network node indicates that reception of downlink data addressed to the wireless device needs to be undertaken with higher priority over performing a measurement or measurement reporting.

15. The wireless device of claim 11, wherein the prioritizing of data traffic for the wireless device corresponds to receiving an uplink priority indication where the network node indicates that transmission of uplink data addressed to the network node needs to be undertaken with higher priority over performing a measurement or measurement reporting.

16. A method implemented in a wireless device that is configured to communicate with a network node, the method comprising:
receiving a measurement request for the wireless device to perform a measurement on a non-operating channel, the measurement request including an indication that the network node is configured to prioritize data traffic for the wireless device; and
transmitting a message associated with the measurement request, the message indicating whether the measurement associated with the measurement request was performed.

17. The method of claim 16, wherein the message is a measurement report that indicates the results of the measurement.

18. The method of claim 16, wherein the message indicates one of:
the measurement was completed, and
the measurement is incomplete.

19. The method of claim 16, wherein the prioritizing of data traffic for the wireless device corresponds to receiving a downlink priority indication where the network node indicates that reception of downlink data addressed to the wireless device needs to be undertaken with higher priority over performing a measurement or measurement reporting.

20. The method of claim 16, wherein the prioritizing of data traffic for the wireless device corresponds to receiving an uplink priority indication where the network node indicates that transmission of uplink data addressed to the network node needs to be undertaken with higher priority over performing a measurement or measurement reporting.
